(19) United States
(12) Patent Application Publication
(10) Pub. No.: US 2008/0011549 A1
(43) Pub. Date: Jan. 17, 2008

(54) SYSTEM FOR ERECTING LADDER STAND FOR HUNTING

(76) Inventor: Chris Lott, Minneapolis, KS (US)

Correspondence Address: THOMPSON & THOMPSON, P.A., P.O BOX 166, SCANDIA, KS, 66966, US

(21) Appl. No.: 11/777,871

(22) Filed: Jul. 13, 2007

Related U.S. Application Data
(60) Provisional application No. 60/830,934, filed on Jul. 14, 2006.

(51) Int. Cl. E06C 1/04; E06C 7/10; E06C 7/42

(52) U.S. Cl. 182/187; 182/217

(57) ABSTRACT

A system for erecting a ladder stand for hunting has a pivoting base assembly connected to a bottom end of a ladder, and a pair of support legs pivotally attached to respective sides of an upper section of the ladder. The pivoting base assembly includes first and second foot pad members, anchoring stakes for anchoring the foot pad members to the ground, a base frame pivotally connected to the foot pad members, and first and second receiver tubes connected to the base frame for receiving the bottom end of the ladder. The pivoting base assembly receives and anchors the bottom end of the ladder and allows the ladder to be easily moved from a horizontal position to an upright position. The support legs have ground pegs at their lower ends for engaging the ground to support the ladder stand in an intermediate position as the ladder stand is being erected.

### RELATED APPLICATIONS

This application claims priority of U.S. Provisional Application No. 60/830,934 filed on Jul. 14, 2006. The content of this prior application is incorporated herein by reference.

### BACKGROUND OF THE INVENTION

1. Field of the Invention

The present invention relates generally to ladder-type tree stands for supporting hunters above the ground and, in particular, to systems and methods to facilitate erecting such ladder stands in the field.

2. Description of the Related Art

Ladder stands for hunting are well known and widely used by hunters. Such ladder stands typically comprise a ladder having a bottom end supported on the ground, and a platform supported at the top of the ladder and abutted against the tree. The ladder extends from the ground to the platform to allow the hunter to climb up to the platform.

Conventional ladder stands are difficult to erect in the field and often require two people to complete the task. A system is needed to make it easier for a single person to raise the ladder and platform to erect the ladder stand in the field.

### SUMMARY OF THE INVENTION

A system for erecting a ladder stand for hunting has a pivoting base assembly connected to a bottom end of a ladder, and a pair of support legs pivotally attached to respective sides of an upper section of the ladder. The pivoting base assembly includes first and second foot pad members, anchoring stakes for anchoring the foot pad members to the ground, and a base frame pivotally connected to the foot pad members with a connection that allows level adjustment to accommodate uneven terrain. First and second receiver tubes are connected to the base frame for receiving the bottom end of the ladder. A spacing between the receiver tubes is adjustable to accommodate different ladder sizes. The pivoting base assembly receives and anchors the bottom end of the ladder and allows the ladder to be easily moved from a horizontal position to an upright position. The base assembly is substantially wider than the ladder to provide a more stable support for the ladder. The support legs have ground pegs at their lower ends for engaging the ground to support the ladder stand in an intermediate position as the ladder stand is being erected. The support legs also serve as handles for moving the stand from its intermediate position to its upright position.

According to a broad aspect of the present invention, a support assembly for a ladder is provided, comprising: first and second foot pad members; means for anchoring the foot pad members to the ground; a base frame having a cross member and means at each end of the cross member for pivotally connecting the base frame to the foot pad members; and first and second receiver tubes connected to the cross member for receiving lower ends of a ladder. The support assembly functions to receive and anchor the lower ends of the ladder and allows the ladder to be pivoted relative to the foot pad members from a horizontal position to an upright position.

According to another broad aspect of the present invention, a system for erecting a ladder stand is provided, comprising: a pivoting base assembly adapted to be connected to a bottom end of a ladder for anchoring and allowing the ladder to pivot relative to the ground at its bottom end; and a pair of support legs having attachment structures at upper ends thereof for pivotal attachment to respective sides of an upper section of the ladder, and ground pegs at lower ends for engaging the ground.

According to yet another embodiment of the present invention, a ladder stand for hunting is provided, comprising: a ladder having a bottom end and an upper section spaced from the bottom end; a pivoting base assembly connected to the bottom end of the ladder for anchoring the bottom end to the ground and allowing the ladder to pivot relative to the ground; and a pair of support legs pivotally attached at upper ends thereof to respective sides of the upper section of the ladder, the support legs having ground pegs at lower ends thereof for engaging the ground to support the ladder stand in an intermediate position as the ladder stand is being erected.

Numerous other objects and features of the present invention will be apparent to those skilled in this art from the following description wherein there is shown and described exemplary embodiments of the present invention, simply by way of illustration of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### BRIEF DESCRIPTION OF THE DRAWINGS

The present invention will become more clearly appreciated as the disclosure of the present invention is made with reference to the accompanying drawings. In the drawings:

FIG. 1 is a perspective side view of a system for erecting ladder stands for hunting according the present invention.

FIG. 2 is a side view of the system shown in FIG. 1, with the ladder stand in an intermediate position supported by the support legs.

FIG. 3 is a side view of the system shown in FIG. 1, with the ladder stand in an upright position.

FIG. 4 is a perspective view of the system shown in FIG. 1, with the ladder stand supported against a tree and the support legs used to provide additional bracing.

FIG. 5 is a perspective view of the system shown in FIG. 1, with the ladder stand supported against a tree and the support legs attached to the sides of the ladder in their stowed positions.

FIG. 6 is a front view of the pivoting base assembly used in the present invention.

FIG. 7 is a perspective view of the pivoting base assembly in an intermediate position.

FIG. 8 is a perspective view of the pivoting base assembly in an upright position.

FIG. 9 is a side view of the pivoting base assembly in its intermediate position.

FIG. 10 is a side view of the pivoting base assembly in its upright position.

FIG. 11 is a detail view of the attachment structure for attaching the support legs to the ladder.

### DETAILED DESCRIPTION OF THE INVENTION

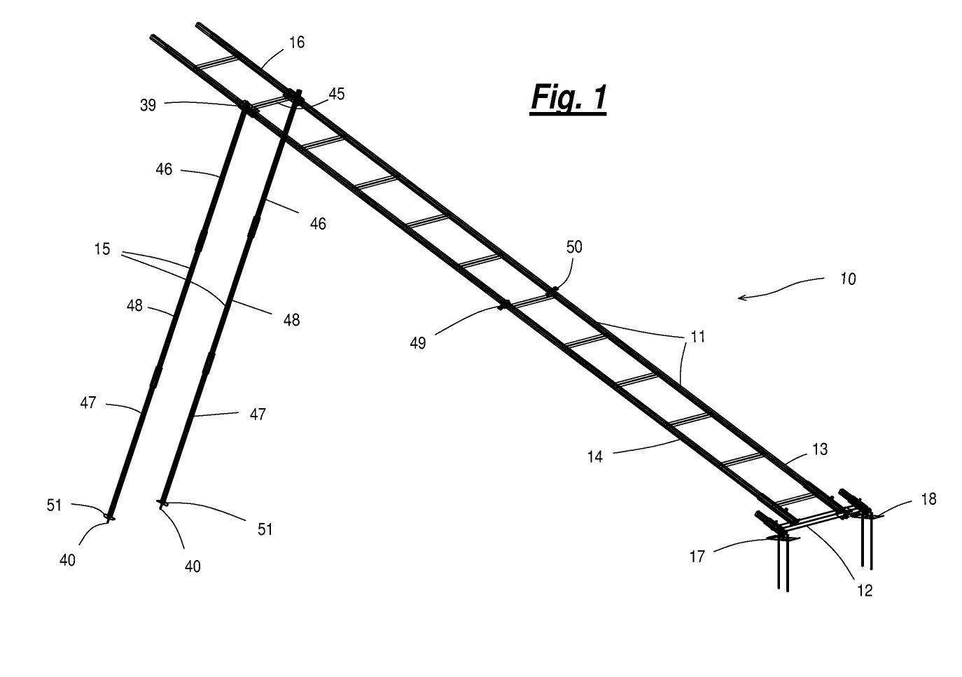

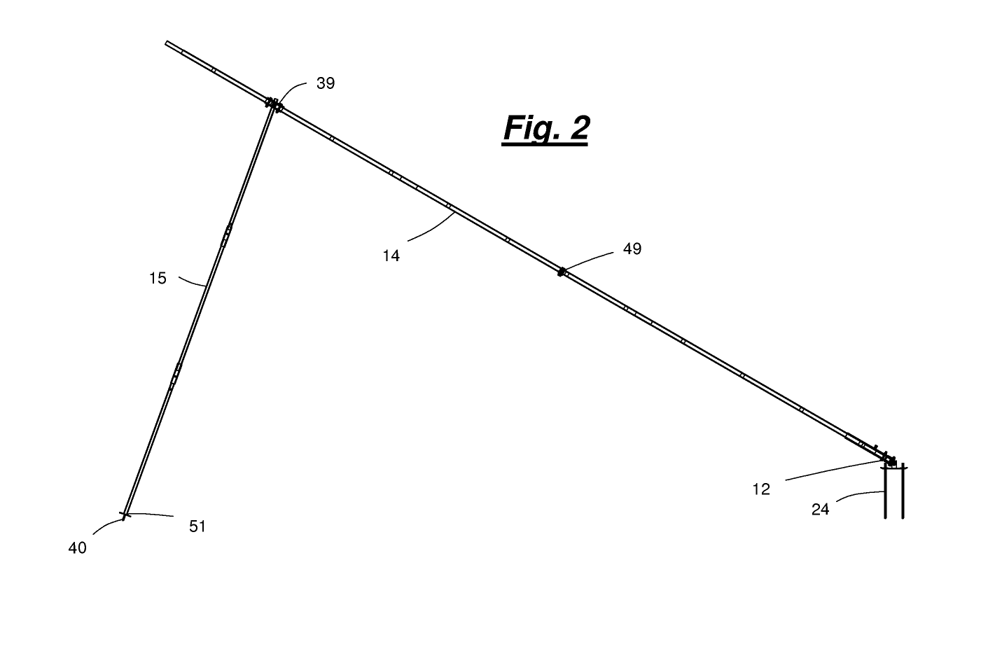

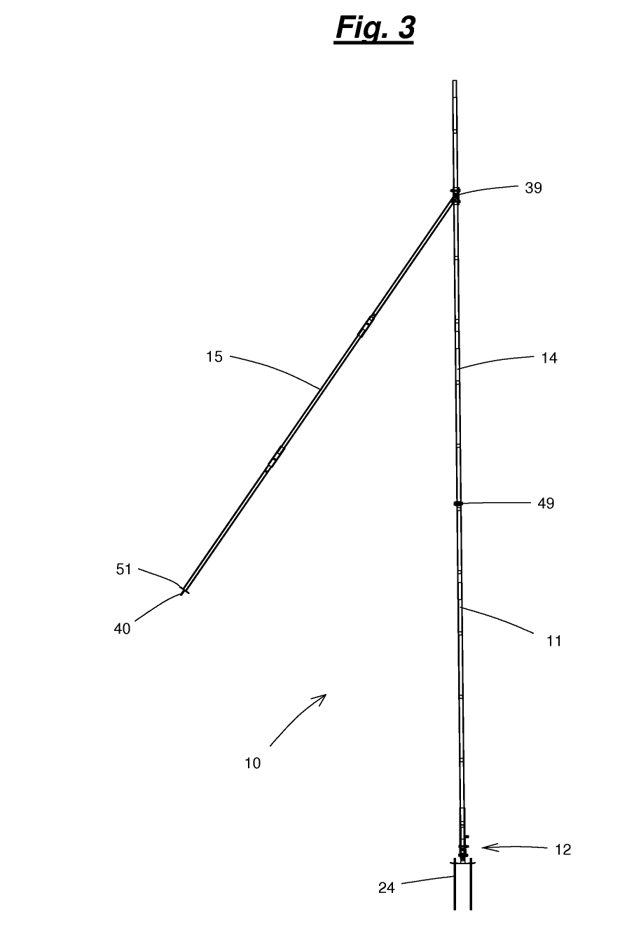

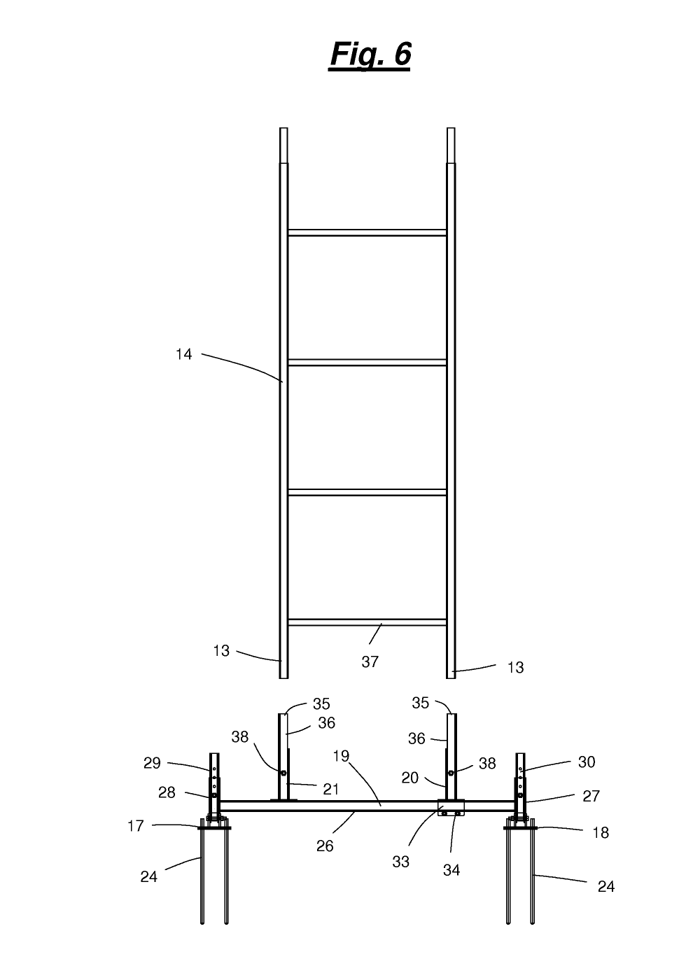

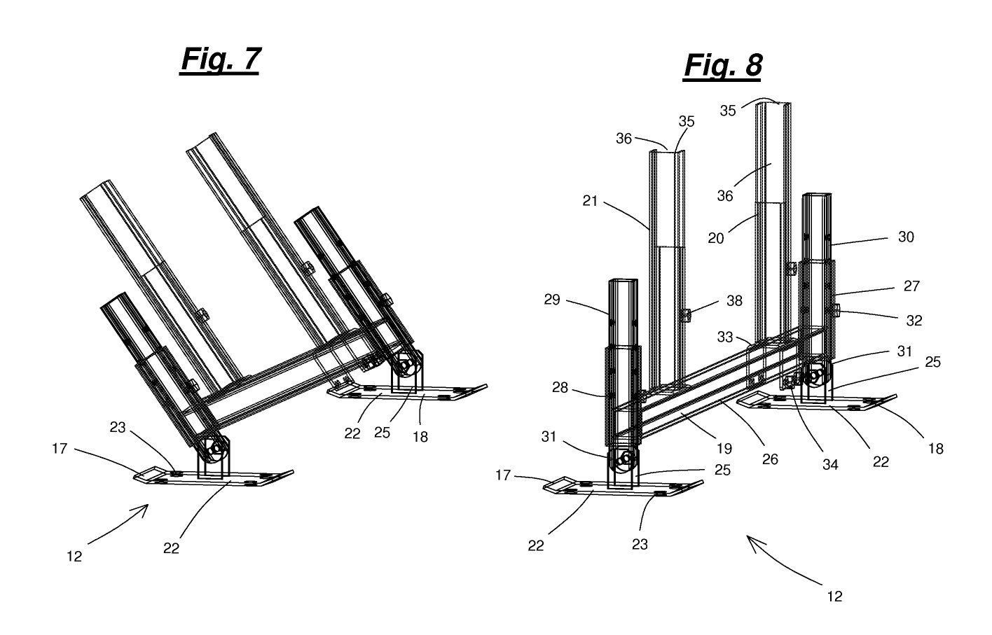

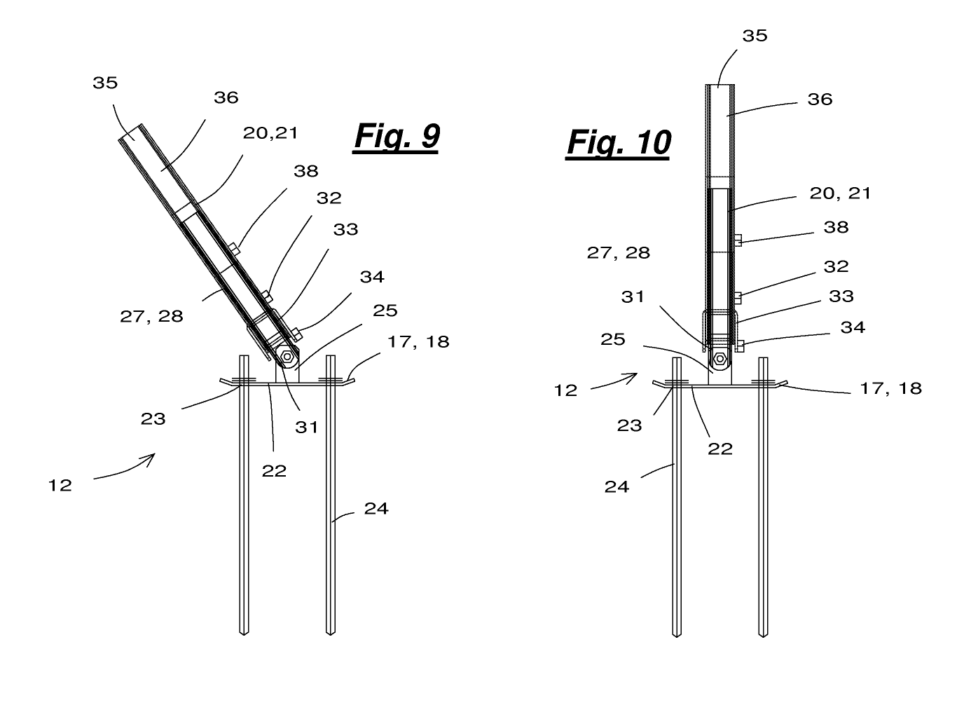

A system for erecting ladder stands for hunting according to the present invention will now be described in detail with reference to FIGS. 1 to 11 of the accompanying drawings.

The present invention provides a system 10 for erecting a ladder stand 11 for hunting. The system 10 has been developed as an add-on accessory for use with existing ladder stands and has features that allow it to be adapted to various sizes and styles of existing ladder stands. However, it will be appreciated by those skilled in the art that some of the core concepts of the present invention can be built into new ladder stands as OEM features to provide improvements over existing techniques and products used to erect ladder stands.

The system 10 has two main components: a pivoting base assembly 12 adapted to be connected to a bottom end 13 of a ladder 14; and a pair of support legs 15 pivotally attached to respective sides of an upper section 16 of the ladder 14. Each of these components 12, 15 will be described in turn, and it should be understood that each component may have separate utility from the other. For example, the pivoting base assembly 12 can be used to facilitate erecting a ladder stand, even if the support legs 15 are not used.

The pivoting base assembly 12 receives and anchors the bottom end 13 of the ladder 14 of a ladder stand 11 and allows the ladder 14 to be pivoted from a horizontal position to an upright position. The base assembly 12 includes first and second foot pad members 17, 18, a base frame 19 pivotally connected to the foot pad members 17, 18, and first and second receiver tubes 20, 21 connected to the base frame 19. The base frame 19 is substantially wider than the ladder 14 to provide a stable support for the ladder 14.

The foot pad members 17, 18 comprise flat plates 22 that engage the ground during use to support the base assembly 12. The flat plates 22 have openings 23 therethrough for receiving anchor stakes 24 that are driven into the ground to anchor the flat plates 22 to the ground. Flanges 25 extend upwardly from the flat plates 22 and have openings therethrough for pivotally connecting the foot pad members 17, 18 to the base frame 19.

The base frame 19 includes a cross member 26 and receiver members 27, 28 secured to each end of the cross member 26. Leg members 29, 30 are slidably received in each of the receiver members 27, 28 and can be vertically adjusted within the receiver members 27, 28. The lower ends 31 of the leg members 29, 30 are pivotally connected to the upwardly extending flanges 25 of the foot pad members 17, 18 and provide a means for pivotally connecting the base frame 19 to the foot pad members 17, 18. Various other structures can also be used as a means for pivotally connecting the base frame 19 to the foot pad members 17, 18, and the particular structure illustrated should not be viewed as limiting the scope of the present invention.

The leg members 29, 30 are adjustable relative to the cross member 26 of the base frame 19 by sliding the leg members 29, 30 within the receiver members 27, 28 to a desired vertical position, and inserting a pin member 32 through aligned bores of the receiver members 27, 28 and the leg members 29, 30 to secure the leg members 29, 30 in the desired position. It will be appreciated by those skilled in the art that other common fasteners can be used instead of the illustrated pin members 32 to secure the leg members 29, 30 in their adjusted positions. Adjustment of the leg members 29, 30 can be used to provide a leveling adjustment feature for the pivoting base assembly 12, which allows the base assembly 12 to adapt to uneven terrain and/or sloping terrain.

The receiver tubes 20, 21 are connected to the base frame 19 for receiving the bottom, lower ends 13 of the ladder 14. A first one of the receiver tubes 20 is adjustable along the cross member 26 so that a spacing between the first and second receiver tubes 20, 21 can be adjusted to accommodate different ladder sizes. The first receiver tube 20 has a saddle structure 33 connected at its lower end, which fits over the cross member 26. Threaded fasteners or pin members 34 serve as a means for securing the saddle structure 33 to the cross member 26 in its adjusted position. The second receiver tube 21 can be either fixed permanently to the cross member 26 (e.g., by welding), or can be adjustably attached in a manner similar to the attachment of the first receiver tube 20.

The receiver tubes 20, 21 in the illustrated embodiment are formed of square tubing. However, other receiver structures, such as round tubing or channel members, can also be used and still accomplish the same functions of the invention. The receiver tubes 20, 21 have one end attached to the cross member 26 as described above, and an open free end 35. A section of the tubing adjacent to the open free end 35 has an open inner side 36 to accommodate a lower step 37 of the ladder 14. The open inner side 36 also facilitates inserting and removing the lower ends 13 of the ladder 14 into the receiver tubes 20, 21. A clamp structure 38, such as a set screw, is provided for fixing the lower ends 13 of the ladder 14 within the first and second receiver tubes 20, 21.

As mentioned above, the other main component of the present invention is the pair of support legs 15. The support legs 15 have attachment structures 39 at their upper ends for pivotal attachment to respective sides of an upper section 16 of the ladder, and ground pegs 40 at their lower ends for engaging the ground.

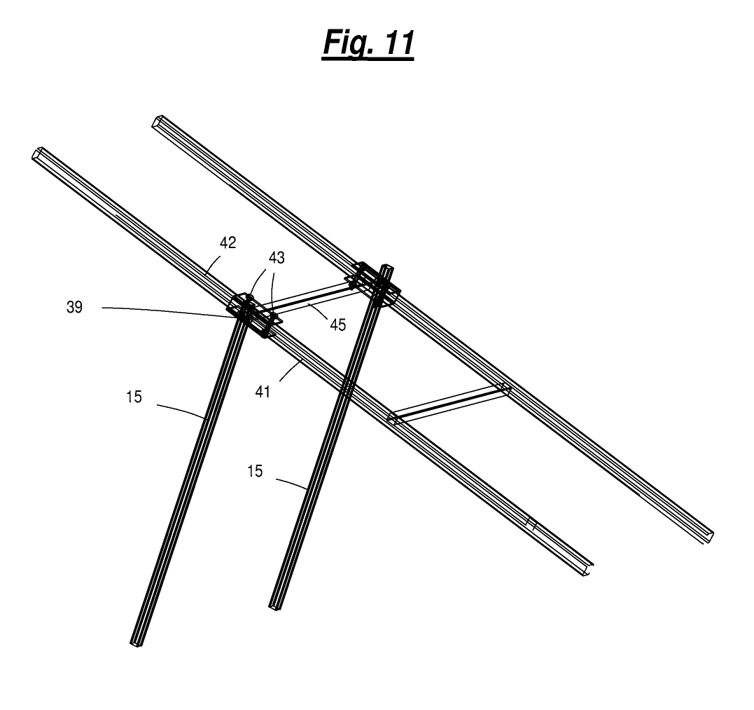

The attachment structures 39 at the upper ends of the support legs 15 are shown in detail in FIG. 11. The attachment structures 39 comprise channel members 41 that fit over the side sections 42 of the ladder 14, and pin members 43 that extend through openings in the channel members 41 to secure the channel members 41 to the side sections 42. The openings on each channel member 41 are arranged so that the pin members 43 can extend on each side of a step 45 of the ladder 14 to thereby keep the channel member 41 in a desired position along the length of the ladder 14.

The support legs 15 comprise tubular members that are pivotally attached to the channel members 41 at their upper ends and to the ground pegs 40 at their lower ends. The tubular members each comprises a top section 46, a bottom section 47, and an extension section 48 connected between the top and bottom sections 46, 47. The sections 46, 47, 48 of the support legs 15 are separable to make the system more compact for transport and storage, and to allow the system to be adjusted in length to accommodate different ladder lengths.

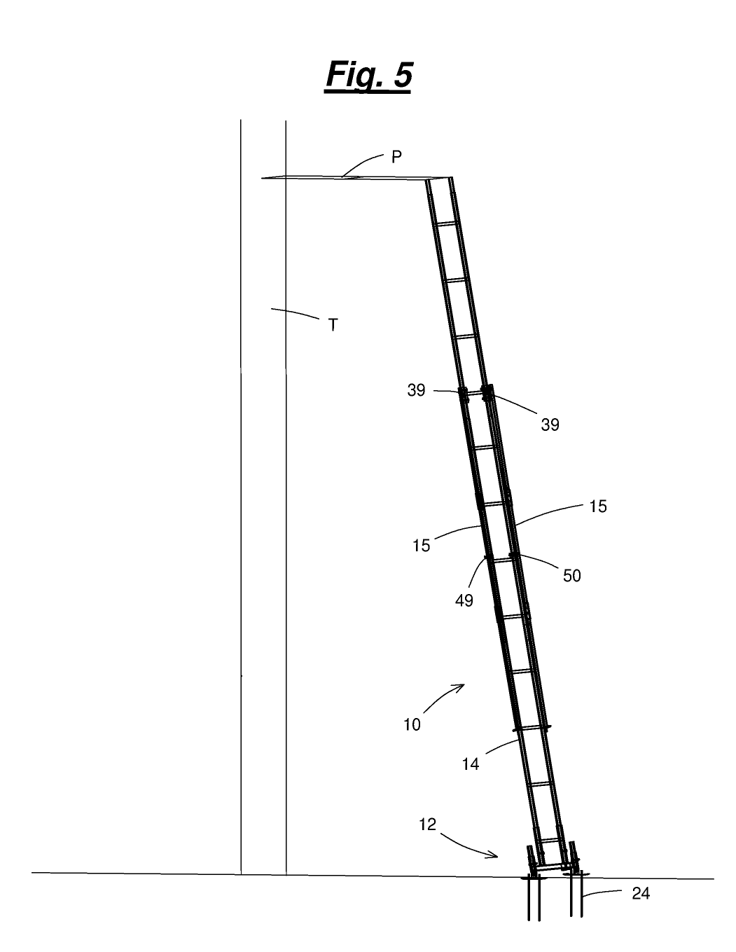

In one embodiment, a pair of stow clips 49, 50 are attached to respective sides of the ladder 14 between the lower ends 13 and the upper section 16 of the ladder 14. The stow clips 49, 50 can be used to secure the support legs 15 to the sides of the ladder 14 when the support legs 15 are not in use, as shown in FIG. 5.

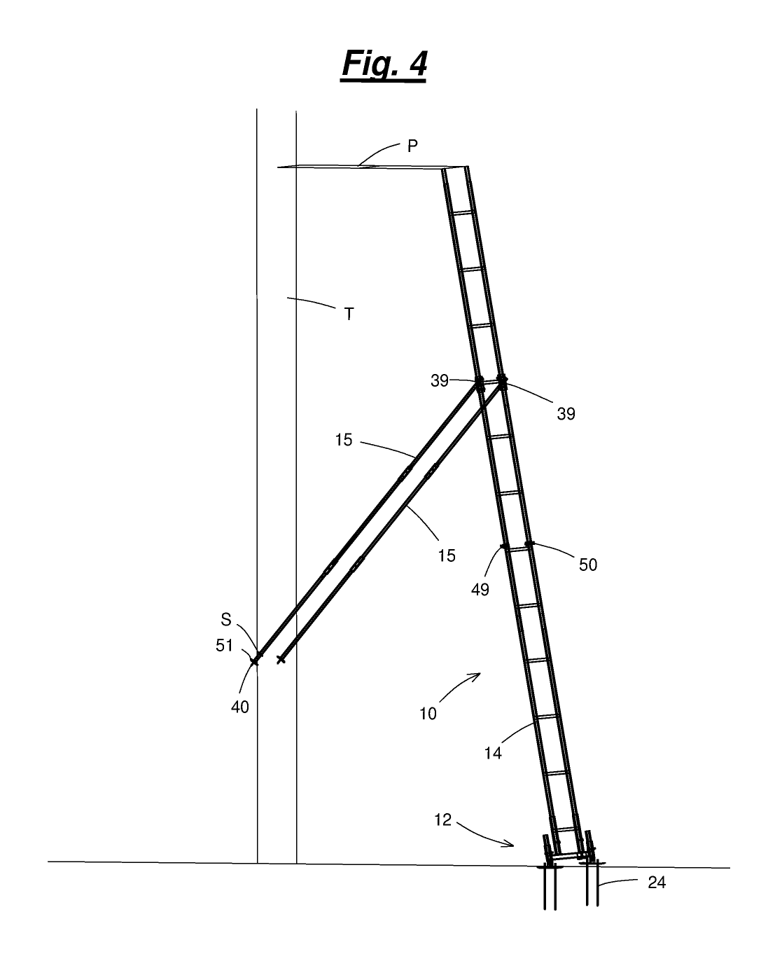

As shown in FIG. 4, the support legs 15 can also be used to provide additional bracing against a tree T or other vertical structure when the ladder stand 11 is in its upright, erected position. In this case, the support legs 15 can be attached to the tree using a lag screw S or the like that extends through an opening near the lower end of each support leg 15 and into the tree. The lag screw S can be provided with a wing head structure that can be gripped by a user's fingers to allow a user to screw the lag screw S into the tree by hand without using a wrench.

The ground pegs 40 at the lower ends of the support legs 15 are slender, pointed members that are designed to penetrate the ground during normal use. Washers 51 or other suitable structures are provided at the upper ends of the ground pegs 40 for limiting the depth of penetration into the ground.

The construction of the system 10 for erecting a ladder stand 11 for hunting according to an embodiment of the present invention has been described above. A method of using the system 10 will now be described.

The user first determines a desired location for the ladder stand 11. For example, ladder stands are typically attached to a tree T or other upright structure in an area to be hunted. Once the location is determined, the user will determine a suitable location for the bottom end 13 of the ladder 14 of the stand 11. The pivoting base assembly 12 can then be anchored to the ground at that location using the anchor stakes 24 positioned in the openings 23 of the foot pad members 17, 18. The bottom end 13 of the ladder 14 is then positioned within the receiver tubes 20, 21 (after adjustment of the spacing between the receiver tubes 20, 21 to adapt to the dimensions of the ladder 14, if necessary), and the set screws 38 are tightened to clamp and secure the lower ends 13 of the ladder 14 within the receiver tubes 20, 21. Alternatively, the ladder 14 and pivoting base assembly 12 can be connected together before the pivoting base assembly 12 is anchored to the ground. The support legs 15 are also attached to the upper section 16 of the ladder 14, with the ground pegs 40 at the lower ends thereof resting on the ground on an opposite side of the platform of the stand 11 (i.e., extending on the other side of the upper end of the ladder stand 14 in the horizontal position).

With the ladder 14 anchored at its bottom end 13 by the pivoting base assembly 12, the user will lift the ladder 14 (and the stand) from its lowered, horizontal position to an intermediate, partially raised position. For example, the user can lift the ladder 14 to as high a position as he can lift comfortably without repositioning himself or gripping a different location on the stand 11. During this lift, the support legs 15 will drag along the surface of the ground until the user relaxes his lift and lets the stand 11 begin to lower. The ground pegs 40 will then penetrate the ground and function to prevent the support legs 15 from sliding across the surface of the ground. Thus, the support legs 15 operate to support the ladder 14 and the stand 11 in the intermediate position until the user can reposition himself.

The user will then grip the support legs 15, one in each hand, and continue to lift the stand 11 (by using the support legs 15 to push the upper end of the stand) in a series of steps or as one final step until the ladder 14 is in its desired upright position. At this point, the ladder 14 and stand 11 can be secured to the tree or other structure and the support legs 15 can be screwed to the sides of the tree to provide additional bracing (FIG. 4), or folded back and attached to the stow clips 49, 50 (FIG. 5) until they are needed again to lower the ladder stand 11 back to the ground.

While the invention has been specifically described in connection with specific embodiments thereof, it is to be understood that this is by way of illustration and not of limitation, and the scope of the appended claims should be construed as broadly as the prior art will permit.

What is claimed is:

1. A support assembly for a ladder, comprising:
first and second foot pad members;
means for anchoring the foot pad members to the ground;
a base frame having a cross member and means at each end of the cross member for pivotally connecting the base frame to the foot pad members; and
first and second receiver structures connected to the cross member for receiving lower ends of a ladder, whereby the support assembly receives and anchors the lower ends of the ladder and allows the ladder to be pivoted relative to the foot pad members from a horizontal position to an upright position.

2. The support assembly according to claim 1, wherein said means for anchoring the foot pad members to the ground comprises anchor stakes that are driven into the ground.

3. The support assembly according to claim 1, wherein said means for pivotally connecting the base frame to the foot pad members comprises receiver members secured to each end of the cross member, and leg members received in the receiver members, said leg members being pivotally connected to the foot pad members.

4. The support assembly according to claim 3, wherein said leg members are adjustable relative to the receiver members to provide a level adjustment for the base frame, and further comprising means for securing the leg members to the receiver members in an adjusted position.

5. The support assembly according to claim 1, wherein at least one of the first and second receiver structures is adjustable along the cross member so that a spacing between the first and second receiver structures can be adjusted to accommodate different ladder sizes.

6. The support assembly according to claim 5, wherein said first receiver structure has a saddle structure connected at its lower end which fits over the cross member, and further comprising a means for securing the saddle structure to the cross member in its adjusted position.

7. The support assembly according to claim 1, further comprising a clamp structure for fixing the lower ends of a ladder within the first and second receiver structures.

8. The support assembly according to claim 7, wherein said receiver structures are each formed of tubing having one end attached to the cross member and an open free end, and a section of the tubing adjacent to the open free end has an open inner side to accommodate a lower step of the ladder and facilitate inserting the lower ends of the ladder into the receiver structures.

9. The support assembly according to claim 1, wherein said foot pad members comprise plates that engage the ground during use, and the plates have openings therethrough for receiving anchor stakes to anchor the plates to the ground.

10. The support assembly according to claim 9, wherein said foot pad members further comprise flanges that extend upwardly from the plates, and said means for pivotally connecting the base frame to the foot pad members comprises leg members supported at each end of the cross member that are pivotally connected to the flanges.

11. The support assembly according to claim 1, wherein said base frame is substantially wider than the ladder to provide a stable support for the ladder.

12. A system for erecting a ladder stand, comprising:
a pivoting base assembly adapted to be connected to a bottom end of a ladder for anchoring and allowing the ladder to pivot relative to the ground at its bottom end; and
a pair of support legs having attachment structures at upper ends thereof for pivotal attachment to respective sides of an upper section of the ladder, and ground pegs at lower ends of the support legs for engaging the ground.

13. The system according to claim 12, wherein each of said attachment structures comprise channel members that fit over side sections of a ladder and pin members that extend through openings on the channel members to secure the channel members to the side sections of the ladder.

14. The system according to claim 13, wherein the openings on each channel member are arranged so that the pin members can extend on each side of a step of the ladder to keep the channel member in a desired position along a length of the ladder.

15. The system according to claim 14, wherein said support legs each comprises a bottom section, a top section, and an extension section connected between the top and bottom sections, said sections being separable to facilitate transport and storage.

16. The system according to claim 12, further comprising a pair of stow clips adapted to be attached to respective sides of the ladder between the lower ends and the upper section of the ladder to secure the support legs to the sides of the ladder after the ladder stand is erected.

17. The system according to claim 12, further comprising a means for securing the support legs to a tree to provide additional bracing for the ladder stand after the support legs are used to erect the ladder stand.

18. The system according to claim 12, wherein the ground pegs each comprises a slender member for penetrating the ground and a means for limiting the depth of penetration.

20. The system according to claim 12, wherein said pivoting base assembly comprises:
first and second foot pad members;
means for anchoring the foot pad members to the ground;
a base frame having a cross member and means at each end of the cross member for pivotally connecting the base frame to the foot pad members; and
first and second receiver tubes connected to the cross member for receiving lower ends of the ladder, whereby the pivoting base assembly receives and anchors the lower ends of the ladder and allows the ladder to be pivoted from a horizontal position to an upright position.

21. A ladder stand for hunting, comprising:
a ladder having a bottom end and an upper section spaced from the bottom end;
a pivoting base assembly connected to the bottom end of the ladder for anchoring the bottom end to the ground and allowing the ladder to pivot relative to the ground; and
a pair of support legs pivotally attached at upper ends thereof to respective sides of the upper section of the ladder, said support legs having ground pegs at lower ends thereof for engaging the ground to support the ladder stand in an intermediate position as the ladder stand is being erected.

22. The ladder stand according to claim 21, further comprising a pair of stow clips adapted to be attached to respective sides of the ladder between the bottom end and the upper section of the ladder to secure the support legs to the sides of the ladder when the support legs are not being used to erect the ladder stand.

22. The ladder stand according to claim 21, further comprising a means for securing the support legs to a tree to provide additional bracing for the ladder stand after the support legs are used to erect the ladder stand.

23. The system according to claim 21, wherein said pivoting base assembly comprises:
first and second foot pad members;
means for anchoring the foot pad members to the ground;
a base frame having a cross member and means at each end of the cross member for pivotally connecting the base frame to the foot pad members; and
first and second receiver tubes connected to the cross member for receiving the bottom end of the ladder, whereby the pivoting base assembly receives and anchors the bottom end of the ladder and allows the ladder to be pivoted from a horizontal position to an upright position.
